(19) United States
(12) Patent Application Publication
(10) Pub. No.: US 2026/0242522 A1
(43) Pub. Date: Aug. 20, 2026

(54) CROWN ETHER INTEGRATED POLYMER FOR SR-90 CAPTURE AND SYNTHESIS METHODS

(71) Applicant: ABILENE CHRISTIAN UNIVERSITY, Abilene, TX (US)

(72) Inventors: Zane Frost, Abilene, TX (US); Jackson Shoultz, Abilene, TX (US); Kim Pamplin, Abilene, TX (US); Diego Zometa, Abilene, TX (US)

(21) Appl. No.: 19/539,511

(22) Filed: Feb. 13, 2026

Related U.S. Application Data
(60) Provisional application No. 63/758,688, filed on Feb. 14, 2025.

(51) Int. Cl. C08F 220/06; B01J 20/26

(52) U.S. Cl. CPC C08F 220/06; B01J 20/264

(57) ABSTRACT

A crown ether integrated polymer may be used to enable solid phase extraction of strontium-90 from an aqueous solution of various fission products. The crown ether integrated polymer may generally be a polymerized 18-crown-6 ether. Polymerization may be accomplished through a variety of different synthesis schemes that leverage Friedel-Crafts alkylation, a Merrifield resin, or form an ether-linked polymer. The crown ether integrated polymer enables solid phase extraction techniques that promote high adsorption, chemical stability, and reusability.

### RELATED APPLICATION

The present application relates and claims priority to U.S. Provisional Application No. 63/758,688, filed on Feb. 14, 2025, which is hereby incorporated by reference in its entirety.

### TECHNICAL FIELD

The described examples relate generally to methods of capturing strontium-90 and synthesis of chemical species for facilitating the same.

### BACKGROUND

Nuclear fission reactions produce a wide spectrum of fission fragments or products either directly or indirectly. A number of these fission products are valuable medical radioisotopes necessary for many cancer treatments and diagnostic procedures. Such radioisotopes may be present in the reactor's coolant, waste, and/or spent fuel. It is desirable to capture and isolate certain medical radioisotopes from the remaining fission products, in particular, strontium-90 which is commonly used to treat bone cancer. Strontium-90 is known to be captured by 18-crown-6 ether structures. However, known methods utilizing 18-crown-6 ether are deficient and fail to promote high adsorption rates, chemical stability, and reusability. As such, there is a need for improved methods of capturing strontium-90 utilizing 18-crown-6 ether structures.

### SUMMARY

In one example, a method of capturing strontium-90 from an aqueous solution is disclosed. The method includes providing an aqueous solution comprising strontium-90; acidifying the aqueous solution; and exposing the aqueous solution to an ether-linked polymer comprising a plurality of dibenzo-18-crown-6 moieties covalently bonded to one another through alkyl or benzyl ether linkages.

In another example, the exposing includes solid-phase extraction of the strontium-90 from the aqueous solution.

In another example, the exposing step is done under cooling conditions.

In another example, the acidifying step includes adding nitric acid in two molar to five molar concentration to the aqueous solution.

In another example, the aqueous solution includes dissolved fission products from a molten salt reactor.

In another example, a method for synthesizing a crown-ether-integrated polymer through Friedel-Crafts alkylation is disclosed. The method includes combining a first solution that includes dibenzo-18-crown-6 ether and a polysubstituted alkyl halide selected from the group consisting of 1,2-dichloroethane, oxalyl chloride, and chloroacetyl chloride with a second solution that includes aluminum trichloride and said polysubstituted alkyl halide to produce a reaction mixture; rinsing the reaction mixture; separating an organic layer from the reaction mixture; and collecting a precipitate from the organic layer, wherein the precipitate comprises the crown-ether-integrated polymer.

In another example, the polysubstituted alkyl halide includes 1,2-dichloroethane and the mole ratio of aluminum trichloride to 1,2-dichloroethane to dibenzo-18-crown-6 ether is 4:2:1.

In another example, the method further includes capturing hydrogen chloride gas evolved during the combining step via a bubbling system.

In another example, the method further includes boiling an ethanol solution that contains the precipitate.

In another example, a method for synthesizing a crown-ether-integrated polymer is disclosed. The method includes combining a first solution comprising a crown ether selected from dibenzo-18-crown-6 ether or benzo-18-crown-6 ether and a Merrifield resin with a second solution that includes aluminum trichloride to produce a reaction mixture; heating the reaction mixture to a boiling point; adding methanol to the reaction mixture; separating an organic layer from the reaction mixture; and collecting a precipitate from the organic layer, and the precipitate includes a crosslinked polymer network that includes a plurality of crown ether moieties covalently bonded to each other and to the Merrifield resin.

In another example, the method further includes capturing and condensing hydrogen chloride gas produced as a byproduct via a bubbling system into a basic solution.

In another example, the combining step is done under cooling conditions.

In another example, a method for synthesizing an ether-linked crown ether polymer is disclosed. The method includes reducing a cis-diformyl dibenzo-18-crown-6 ether with sodium borohydride in ethanol to produce a crown ether dibenzyl alcohol; suspending the crown ether dibenzyl alcohol in dichloromethane; adding sulfuric acid to produce a reaction mixture; heating the reaction mixture under reflux conditions to effect acid-catalyzed dehydrative coupling; and collecting a precipitate comprising the ether-linked crown ether polymer.

In another example, the method further includes, prior to the reducing step, preparing the cis-diformyl dibenzo-18-crown-6 ether by heating dibenzo-18-crown-6 ether with hexamethylenetetramine and trifluoroacetic acid in a 1:3:3 molar ratio.

In another example, the reducing step is performed under cooling conditions.

In another example, a method for synthesizing an ether-linked crown ether polymer is disclosed. The method includes converting a first portion of a crown ether dibenzyl alcohol to an alkyl halide by reaction with hydrochloric acid or thionyl chloride; converting a second portion of the crown ether dibenzyl alcohol to an alkoxide by reaction with sodium tert-butoxide in tert-butyl alcohol; combining the alkyl halide and the alkoxide in tert-butyl alcohol; refluxing to effect coupling; and collecting a precipitate comprising the ether-linked crown ether polymer.

In another example, the crown ether dibenzyl alcohol is derived from dibenzo-18-crown-6 ether.

In another example, the method further includes washing the precipitate with a sodium bicarbonate aqueous solution.

In another example, the molar ratio of sodium tert-butoxide to crown ether dibenzyl alcohol is 2.2:1.

In another example, the converting of the first portion of the crown ether dibenzyl alcohol to an alkyl halide is performed with hydrochloric acid.

In one example, a method of capturing strontium-90 from an aqueous solution is disclosed. The method includes providing an aqueous solution comprising strontium-90. The method further includes acidifying the aqueous solution and exposing the aqueous solution to a crown ether integrated polymer for an amount of time.

In another example, the crown ether integrated polymer includes a polymerized dibenzo-18-crown-6 ether.

In another example, the crown ether integrated polymer comprises an ether-linked polymer.

In another example, the exposing step includes solid phase extraction of the strontium-90 from the aqueous solution.

In another example, the exposing step is done under cooling conditions.

In yet another example, the acidifying step includes adding a nitric acid in two molar to five molar concentration to the aqueous solution.

In one example, a method for synthesizing a crown ether integrated polymer through Friedel-Crafts alkylation is disclosed. The method includes adding a second solution to a first solution to produce a third solution including the crown ether integrated polymer. The first solution includes a crown ether and a first alkyl halide. The crown ether includes dibenzo-18-crown-6 ether. The second solution includes an acid and a second alkyl halide. The acid includes aluminum trichloride. The method further includes rinsing the third solution; separating an organic layer from the third solution; and collecting a precipitate of the organic layer. The precipitate includes the crown ether integrated polymer.

In another example, the crown ether integrated polymer includes a polymerized dibenzo-18-crown-6 ether.

In another example, the first alky halide includes 1,2-dichloroethane, oxalyl chloride, chloroacetyl chloride, and/or a combination comprising dichloromethane and chloroform.

In another example, the second alky halide includes 1,2-dichloroethane, oxalyl chloride, chloroacetyl chloride, and/or a combination comprising dichloromethane and chloroform.

In another example, the adding step includes dripping the second solution into the first solution via a separatory funnel.

In another example, the adding step further includes capturing and condensing a hydrochloric acid produced as a byproduct of the adding with a bubbling system into a basic solution.

In yet another example, the method further includes, after the separating step, adding an ethanol to the organic layer and boiling the organic layer.

In one example, a method for synthesizing a crown ether integrated polymer with a Merrifield resin is disclosed. The method includes adding a second solution to a first solution to produce a third solution including the crown ether integrated polymer. The first solution includes a crown ether and a first Merrifield resin. The second solution includes an acid and a second Merrifield resin. The acid includes an aluminum trichloride. The method further includes heating the third solution to a boiling point; adding a methanol to the third solution; separating an organic layer from the third solution; and collecting a precipitate of the organic layer. The precipitate includes the crown ether integrated polymer.

In another example, the crown ether includes dibenzo-18-crown-6 ether or benzo-18-crown-6 ether.

In another example, the crown ether integrated polymer includes a polymerized dibenzo-18-crown-6 ether.

In another example, the crown ether integrated polymer includes a polymerized benzo-18-crown-6 ether.

In another example, the adding step further includes capturing and condensing a hydrochloric acid produced as a byproduct of the adding step with a bubbling system into a basic solution.

In yet another example, the adding step is done under cooling conditions.

In one example, a method for synthesizing a crown ether integrated polymer through a Duff reaction is described. The method includes heating a first solution including a crown ether, hexamethylenetetramine, and trifluoroacetic acid. The crown ether includes dibenzo-18-crown-6 ether. The method further includes adding a second solution to the first solution to produce a third solution where the second solution includes ethanol and sodium borohydride; stirring the third solution while cooling the third solution; heating the third solution to evaporate the ethanol and produce a precipitate; suspending the precipitate in a dichloromethane solution to produce a fourth solution; separating an organic layer from the fourth solution; adding a sulfuric acid to the organic layer to produce a fifth solution; stirring the fifth solution under heating conditions; and collecting a precipitate of the fifth solution. The precipitate comprises the crown ether integrated polymer.

In another example, the first solution comprises a 1:3:3 molar ratio of the crown ether, hexamethylenetetramine, and trifluoroacetic acid.

In another example, the crown ether integrated polymer includes a polymerized dibenzo-18-crown-6 ether.

In yet another example, the method further includes, after the suspending step and before the separating step, quenching a reaction with hydrochloric acid to remove excess sodium borohydride.

In another example, a method for synthesizing a crown ether integrated polymer through a Duff reaction is disclosed. The method includes heating the first solution where the first solution includes a crown ether, hexamethylenetetramine, and trifluoroacetic acid. The crown ether includes dibenzo-18-crown-6 ether. The method further includes adding a second solution to the first solution to produce a third solution; the second solution includes ethanol and sodium borohydride; stirring the third solution while cooling the third solution; adding an acid to the third solution under heating conditions; refluxing the third solution; separating an organic layer of the third solution; and washing the organic layer. The method further includes adding a sodium tert-butoxide and tert-butyl alcohol to a fourth solution; the fourth solution including a primary alcohol dibenzo-18-crown-6 ether adding the organic layer of the third solution to the fourth solution producing a fifth solution; refluxing the fifth solution; and collecting a precipitate of the fifth solution. The precipitate comprises the crown ether integrated polymer.

In another example, the crown ether integrated polymer includes a polymerized dibenzo-18-crown-6 ether.

In another example, the first solution includes a 1:3:3 molar ratio of the crown ether, hexamethylenetetramine, and trifluoroacetic acid.

In another example, the washing step is done with a sodium bicarbonate aqueous solution.

In another example, the acid is hydrochloric acid or thionyl chloride.

### BRIEF DESCRIPTION OF THE DRAWINGS

FIG. 1 illustrates an example bubbling system used for synthesis of a crown ether integrated polymer.

FIG. 2 illustrates an example solid phase extraction method.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes example systems, methods, and designs that embody various elements of the present disclosure. However, it should be understood that the described disclosure may be practiced in a variety of forms in addition to those described herein.

The present disclosure contemplates synthesis routes that may utilize greener solvent alternatives. For example, the Duff reaction routes described herein may employ ethanol as a primary solvent in place of dichloromethane. Ethanol is commonly regarded as a more environmentally favorable solvent due to its lower toxicity and improved biodegradability.

The following disclosure generally relates to methods and systems for capturing strontium-90 (Sr-90) from an aqueous solution containing a variety of fission products. The methods and systems disclosed herein utilize a crown ether integrated polymer to facilitate Sr-90 isolation and capture. For example, the crown ether integrated polymer described herein enables solid phase extraction of Sr-90. The present disclosure is further directed to synthesis methods of generating said crown ether integrated polymers.

Medical isotopes are necessary for many cancer treatments and diagnostic procedures. Many of these medical isotopes are not naturally occurring but generated as a byproduct of nuclear fission reactions. For example, Sr-90 is a known fission product generated by such fission reactions. Among the wide variety of nuclear reactors known to produce Sr-90 include Molten Salt Reactors (MSRs). MSRs are configured to produce power and/or heat via fission reaction of fissile material (e.g., uranium) dissolved in a molten salt, collectively a “molten fuel salt” (e.g., LiF—BeF₂—UF₄). Sr-90 is anticipated to be found in the molten fuel salt following fission reactions. In many instances, the molten fuel salt may be removed from the MSR system following the salt's lifecycle or that of the reactor. Thereafter, the fuel salt may be allowed to cool and reach an acceptable level of radioactivity, then dissolved in an aqueous solution for isotope extraction.

Crown ethers (sometimes referred to as “CEs”) are known to adsorb specific cations from aqueous solutions for various purposes. The specific structure and conformation of crown ethers make the molecule extremely selective for an ion of interest. The molecule 18-crown-6 ether (abbreviated as “18C6”) has high selectivity for K⁺ (ion diameter of 2.76 Å) and Sr²⁺ (ion diameter of 2.36 Å) ions because of its central cavity diameter of 2.6-3.2 Å. The structure of 18C6 can be modified through a variety of means to change its chemical properties, making the molecule more hydrophobic or hydrophilic, sterically hindered, and/or open to specific reactions with other compounds.

The generally accepted explanation for how crown ethers are able to adsorb ions from aqueous solutions is through a process called ion exchange. The cavity of the crown ether is a negatively charged environment because of the oxygen atoms in the ring. Assume that initially, the hydrogen atoms on one or two water molecules are attracted to the negative environment of the cavity. A cation like K⁺ with a higher affinity for the cavity than the water molecule will move into the cavity and displace the water. Following adsorption, a complex forms between the cation and the oxygen atoms of the ring of the crown ether. That cation will stay until another cation or molecule with higher affinity comes along to displace it. In some cases, other molecules are thought to join the cation/CE complex. One example is NO³⁻ joining the Sr²⁺/CE complex. It is unclear what causes this to occur, but the Sr²⁺ may have a higher affinity for the cavity of the CE if NO³⁻ is present to help the complex form. It is also possible that the formation of the Sr²⁺/CE complex may create an affinity for NO³⁻, incorporating it into the complex. In this regard, strontium nitrate is known to have a low Gibbs energy formation, consequently making this reaction (i.e., formation of the Sr²⁺/CE/NO³⁻ complex) spontaneous at room temperature. Advantageously, by utilizing the crown ether integrated polymer with an aqueous solution including strontium nitrate (such as one anticipated to be derived from an aqueous solution prepared by used molten fuel salt) adsorbability of the Sr-90 is increased. Additionally, masking agents (e.g., sodium tetraphenylborate) may be included to assist in selectivity of, for example, Sr-90 ions by masking, chelating, or adsorbing other non-Sr-90 ions in the solution. These chemical properties are useful for two reasons. First, the crown ether will show no affinity for any anions, making their presence in solution inconsequential. Second, concentrated nitric acid has been the preferred method for dissolving salt in the past, making the preparation of our aqueous solution easier.

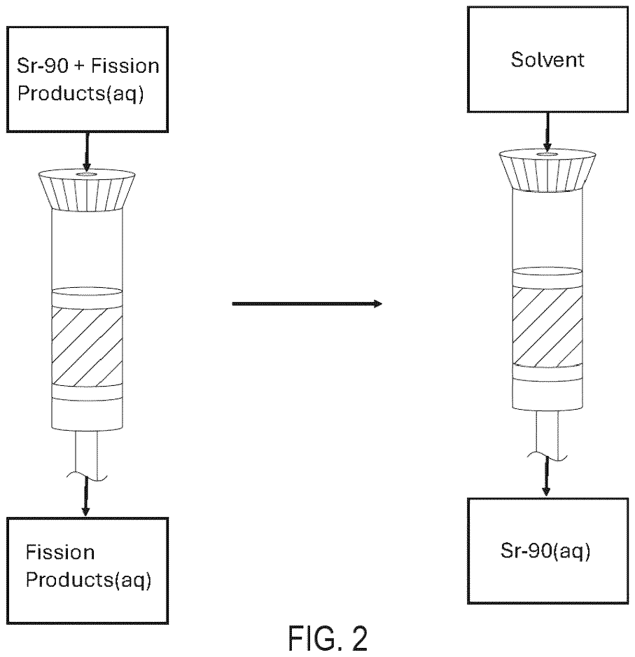

Advantageously, by generating a polymer integrated with an Sr-90 adsorbing crown ether, operators are enabled to facilitate Sr-90 capture utilizing solid phase extraction rather than traditional methods. For example, and as discussed in greater detail with reference to FIG. 2, the crown ether integrated polymer of the present disclosure may be integrated into a filter to be used in a solid phase extraction column. As another example, the crown ether integrated polymer may be employed to remove Sr ions from nuclear waste or spill site.

Additionally, the present disclosure discloses various example synthesis methods for generating the crown ether integrated polymers used for solid phase extraction of Sr-90. For example, and as discussed in greater detail with reference to Schemes X-XII, the crown ether integrated polymer may be generated through Friedel-Crafts alkylation resulting in a polymerized crown ether operable to capture Sr-90. As another example, and as discussed in greater detail with reference to Schemes I and II, the crown ether integrated polymer may be generated utilizing a Merrifield resin (i.e., integrated into a Merrifield resin) resulting in a polymerized crown ether operable to capture Sr-90. As yet another example, and as discussed in greater detail with reference to Schemes III-VIII, the crown ether integrated polymer may be generated leveraging a Duff reaction resulting in a polymerized crown ether operable to capture Sr-90.

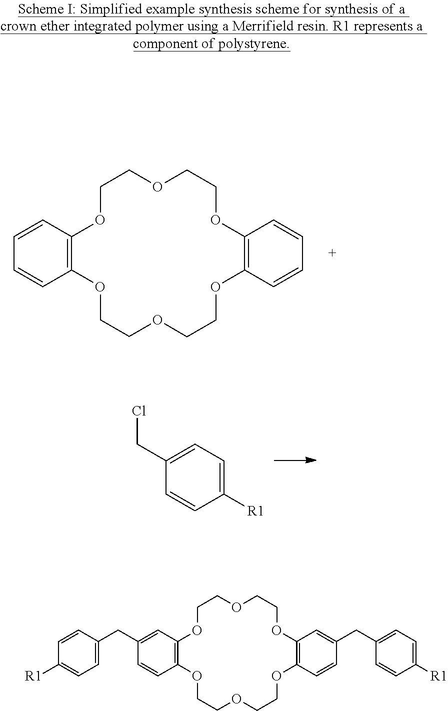

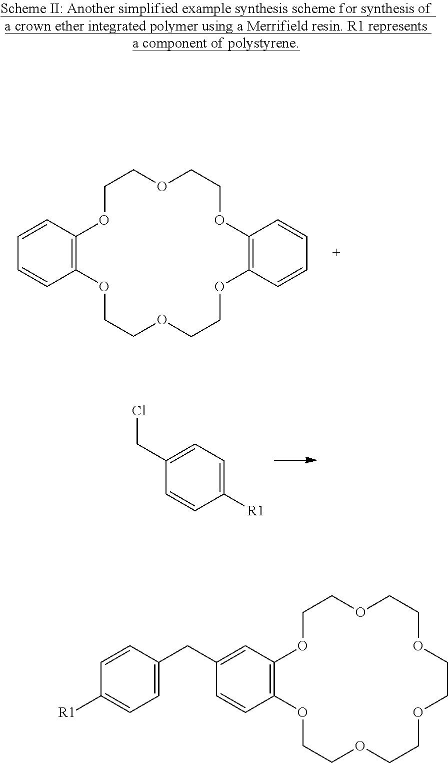

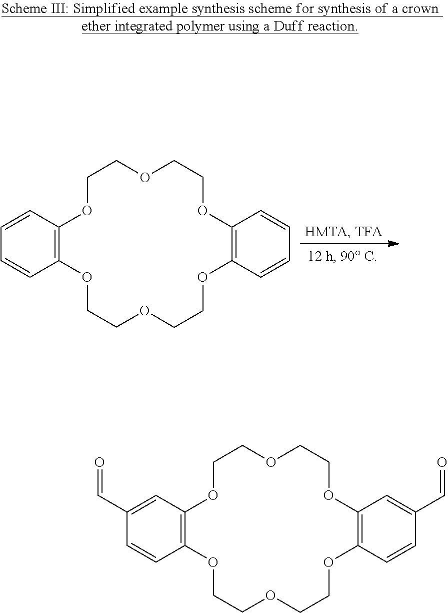 [SMILES: c1ccc2c(c1)OCCOCCOc1ccccc1OCCOCCO2 ; O=Cc1ccc2c(c1)OCCOCCOc1cc(C=O)ccc1OCCOCCO2]

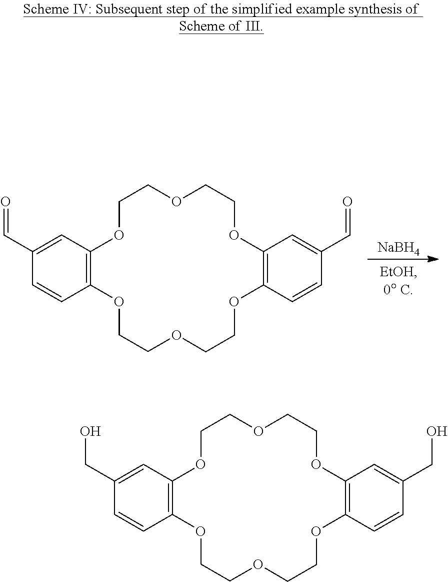

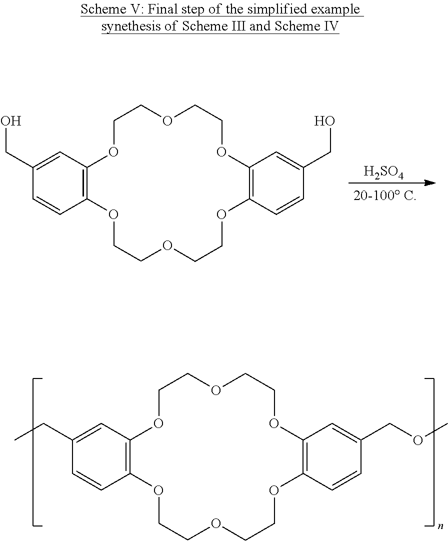

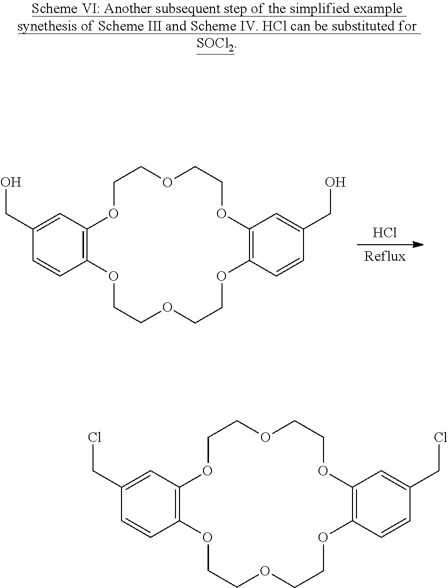 [SMILES: OCc1ccc2c(c1)OCCOCCOc1cc(CO)ccc1OCCOCCO2 ; Cl ; ClCc1ccc2c(c1)OCCOCCOc1cc(CCl)ccc1OCCOCCO2]

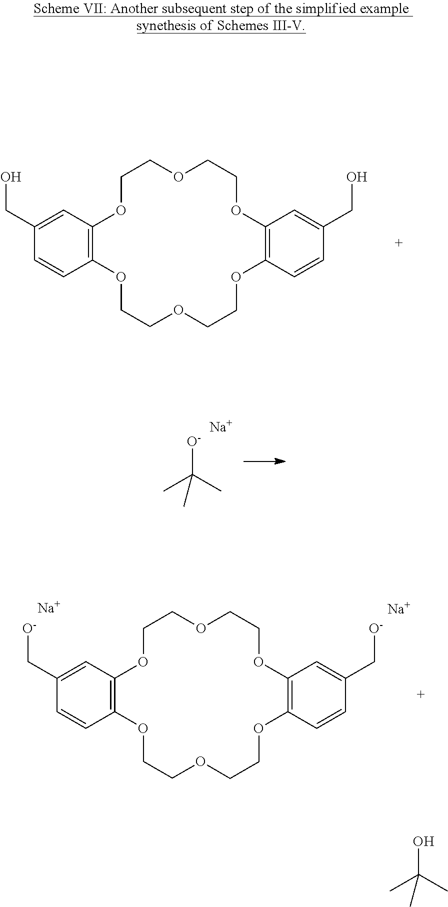

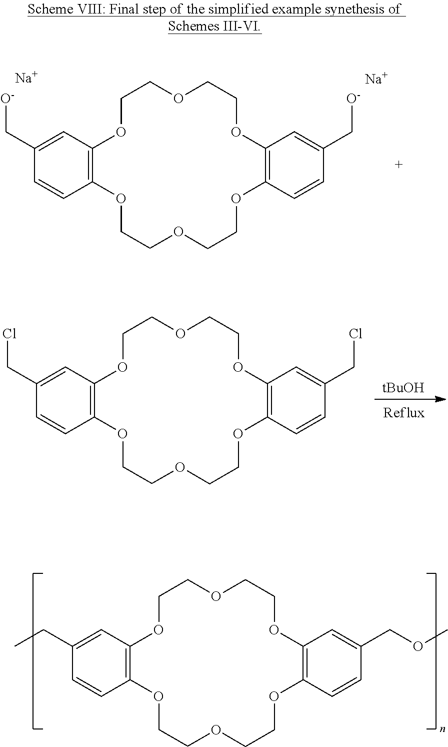

The crown ether integrated polymer of the present disclosure utilizes a crown ether configured to capture Sr-90 ions. For example, the crown ether may be an 18-crown-6 ether. In this regard and as illustrated in Scheme IX the formation of the Sr²⁺/CE (i.e., Sr²⁺/18C6) complex is shown. Such a complex is representative of the mechanism to which the crown ether integrated polymer captures or adsorbs Sr-90. Here, a cationic strontium atom (e.g., Sr-90) is captured within the cavity of the 18C6 molecule. Such an interaction may occur within the aqueous solution prepared from a used molten salt, thereby enabling capture of Sr-90 produced therein. However, as previously discussed, simply adding 18C6 into an aqueous solution of various fission products is inefficient for a variety of reasons (e.g., hydrophilic nature of 18C6, reusability, absorbability, selectivity, etc.). In particular, it is advantageous to utilize an extraction method that is not only selective towards strontium ions and enables liberation of the strontium ions from the 18C6 cavity, but also one which promotes reusability of the system after stripping the strontium ion from the CE. In turn, preparation time and operation cost may be reduced.

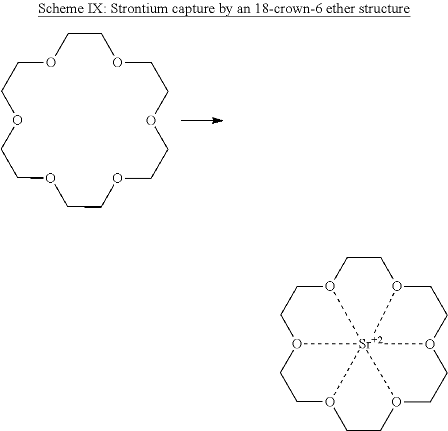

The present disclosure is directed towards providing such a solution and in particular, to a crown ether-based polymer (sometimes referred to as a “crown ether integrated polymer”) configured to enable solid phase extraction of Sr-90 from an aqueous solution, synthesis procedures for the same, and methods of use.

Initially, the particular crown ether selected for polymerization should satisfy certain requirements. For example, the crown ether needs to be able to be modified to facilitate polymerization; the crown ether must be resistant to degradation caused by the aqueous phase, the stripping, and the radiation of the molten salt; the crown ether must have a high affinity to Sr²⁺ ions; and be reusable for multiple adsorptions. Utilizing a polymerized dibenzo-18-crown-6 ether (abbreviated as “DB18C6”) would satisfy the aforementioned requirements. For example, DB18C6 delivers ideal adsorbance and reusability when polymerized. Additionally, by polymerizing DB18C6 solid phase extraction is achievable, which greatly increases ease of use. In this regard and as discussed in greater detail with reference to FIG. 2, a crown ether integrated polymer enables separation of the polymer from the aqueous phase with a simple filter (e.g., solid phase extraction cartridge) rather than requiring a phase separation approach that comes with using an unpolymerized crown ether.

In this regard, the crown ether integrated polymer of the present disclosure may be generated through a variety of synthesis schemes, which the following discussion is directed towards. For example, the crown ether integrated polymer may be synthesized utilizing Friedel-Crafts alkylation, which links DB18C6 ethers to each other through Friedel-Crafts alkylation with dichloromethane or chloroform. As another example, the crown ether integrated polymer may be synthesized utilizing a Merrifield resin. As yet another example, the crown ether integrated polymer may be synthesized utilizing a Duff Reaction.

### Friedel-Crafts Polymer Synthesis

As discussed, the crown ether integrated polymer of the present disclosure may be configured to enable solid phase extraction of Sr-90 in an aqueous solution of various fission products. As illustrated in Schemes X-XII the crown ether integrated polymer may be synthesized utilizing Friedel-Crafts alkylation, which involves exposing a polysubstituted alkyl chloride (e.g., 1,2-dichloroethane or “DCE,” chloroacetyl chloride, oxalyl chloride, or a combination including dichloromethane and chloroform) to a crown ether (e.g., DB18C6). This facilitates a Friedel-Crafts reaction that links several DB18C6 molecules to form a crown ether integrated polymer configured to capture Sr-90.

Initially, the DB18C6 must be alkylated. This may be accomplished by exposing the crown ether to DCE, oxalyl chloride, or chloroacetyl chloride. However, it may be advantageous to utilize DCE as oxalyl chloride and chloroacetyl chloride are extremely toxic and react strongly with water in a reaction already sensitive to water. For example, and with reference to Scheme X, a simplified synthesis scheme for polymerizing DB18C6 with DCE is shown. As another example, and with reference to Scheme XI, a simplified synthesis scheme for polymerizing DB18C6 with oxalyl chloride is shown. As yet another example, and with reference to Scheme XII, a simplified synthesis scheme for polymerizing DB18C6 with chloroacetyl chloride is shown.

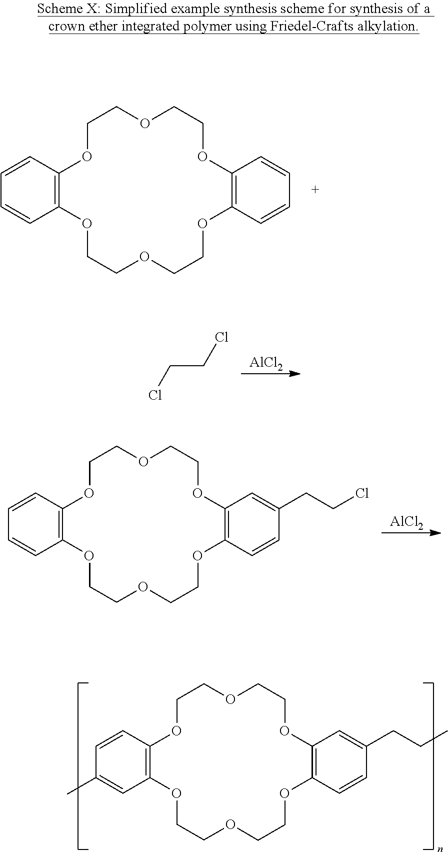

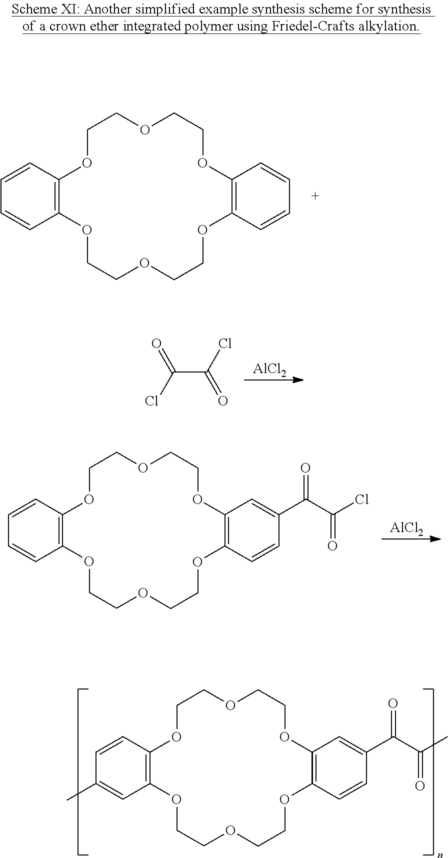

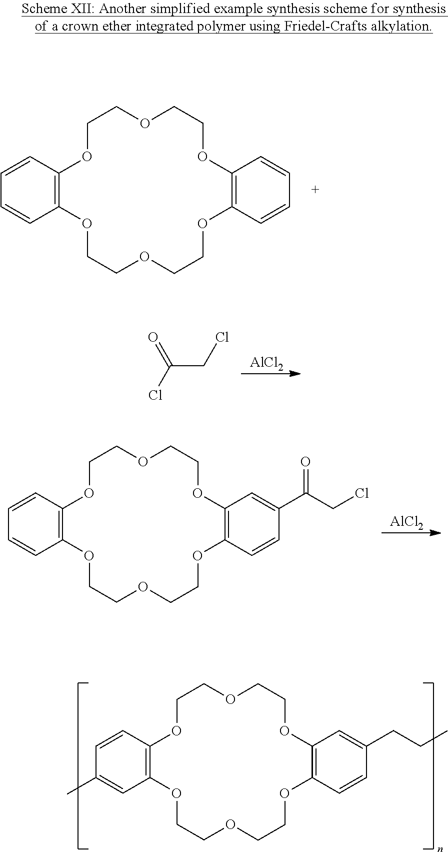

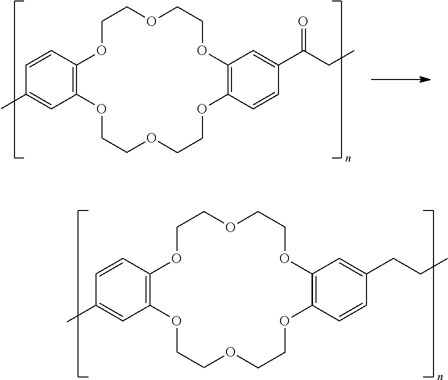

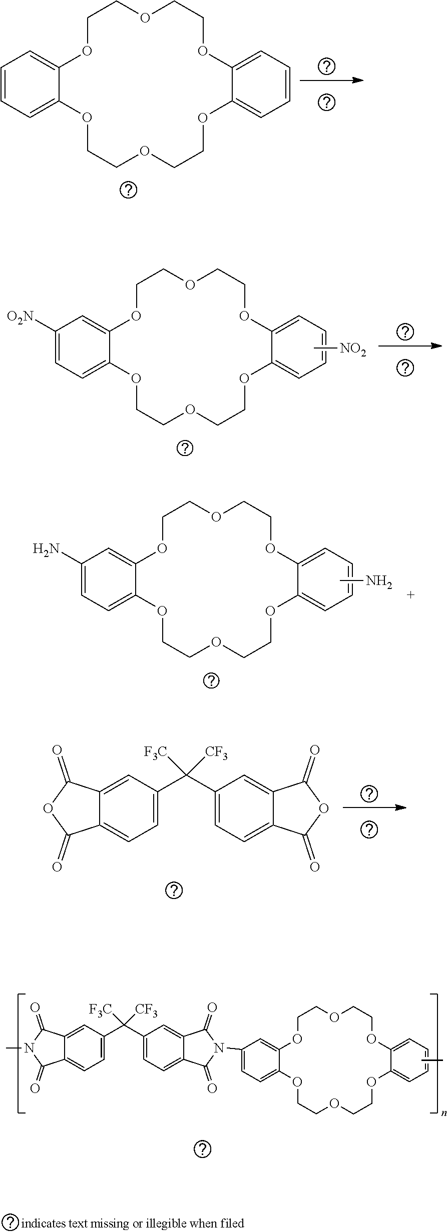

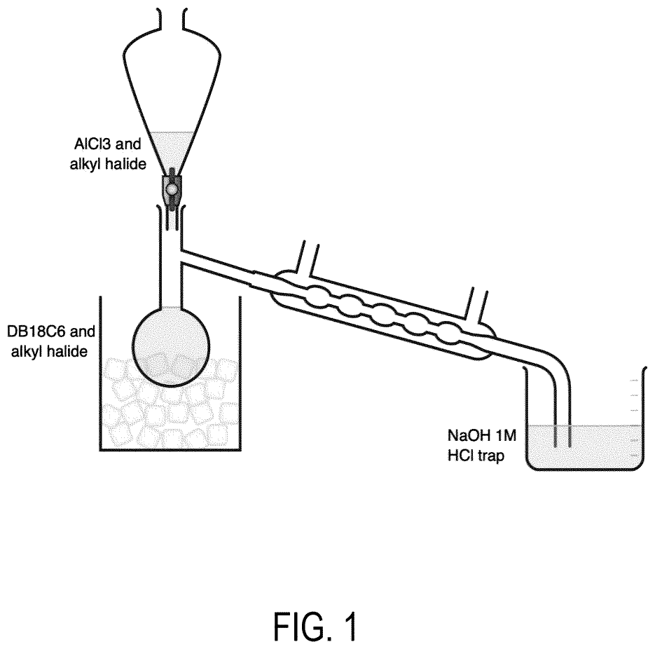

In this regard, such reactions may be facilitated by preparing a first solution including DB18C6 and a polysubstituted alkyl chloride (e.g., DCE, chloroacetyl chloride, or oxalyl chloride) and preparing a second solution including an acid (e.g., aluminum trichloride or iron trichloride) and a DCE. The first solution and the second solution may be added together, resulting in a third solution. The reaction may be designed such that the third solution includes a 4:2:1 mole ration of AlCl₃, DCE, and DB18C6, advantageously ensuring that the crown ether integrated polymer is limited by the DB18C6 and not the other reagents. In one example, the addition of the second solution to the first solution is done under cooling conditions, such as by placing a flask holding the first solution in an ice bath as the second solution is added thereto. The reaction is anticipated to be exothermic, thus cooling conditions may increase product formation. In one example, the second solution is added to a separatory funnel and dripped into the first solution to prevent overboiling, as HCl gas will be produced. In this regard, the bubbling system, such as that illustrated in FIG. 1 may be employed to control the production of HCl. In this regard, the HCl gas may be routed through the bubbling system and submerged into a basic solution (e.g., NaOH).

Following addition of the second solution to the first, the third solution may be cooled and rinsed with deionized water. At this point, the crown ether integrated polymer (i.e., polymerized DB16C6) may be found within the organic layer of the third solution. The organic layer may be isolated, added with a 95% ethanol solution, and then heated to boiling to remove any remaining alkyl halide. The organic solution may be cooled to allow a precipitate to form. Thereafter, a precipitate of the organic layer may be collected (e.g., via vacuum filtration) including the crown ether integrated polymer.

### Friedel-Crafts Polymer Synthesis—Example 1

The following procedure was conducted to synthesize a crown ether integrated polymer. One skilled in the art will appreciate that, while exact measurements and methods are described in this example, minor deviations from the following procedure are still within the scope of the present disclosure.

Initially, as a first experiment, 5.1331 g of FeCl₃ was dissolved in 30 mL of 95% ethanol. The FeCl₃ solution was added to a KONTES Glass 125 mL Dual Scale Constant Addition Funnel containing 100 mL of dichloromethane (DCM). The ethanol and DCM showed a slight degree of immiscibility, but shaking the funnel for a few minutes blended the two solutions well enough to where they would not separate before being added to the dibenzo-18-crown-6 ether (DB18C6). The solution was added at a rate of 3 drops/sec to a round bottom, 2-neck reaction flask with a glass stopcock containing 4.5999 g of DB18C6. Based on estimates, around 4.65 g of DB18C6 would be enough to produce 5 g of crown ether integrated polymer. The bottom half of the flask was submerged in an ice water bath. The glassware was suspended by clamps attached to a ring stand. After the addition, the flask was swirled at room temperature for 15 minutes. The solution was poured off and left to dry in the fume hood. The second experiment was the addition of DCM to AlCl₃ and DB18C6 in the flask. All experiments shared the same glassware setup. The flask was filled with 4.6108 g of DB18C6 and approximately 1 g of AlCl₃. The funnel was filled with 60 mL of DCM and added dropwise at a rate of 3 drops/sec. After the addition, the flask was swirled at room temperature for 15 minutes. This solution was added to a separatory funnel containing 60 mL of concentrated HCl. After separating the two layers, the aqueous phase was filtered, and the organic phase was evaporated. The third experiment included adding DB18C6 dissolved in DCM to AlCl₃. 4.6104 g of DB18C6 was dissolved in 80 mL of DCM, added it to the addition funnel, and added it dropwise at 3 drops/sec to approximately 1 g of AlCl₃. After the addition, the flask was swirled at room temperature for 15 minutes. After extracting with 80 mL of concentrated HCl, the aqueous phase was filtered, and the organic phase was evaporated. Experiment four included adding AlCl₃ dissolved in chloroform to DB18C6. An attempt to dissolve approximately 1 g of AlCl3 in 125 mL of chloroform was done but found that the solubility was much lower than anticipated. Instead, the solution was agitated to keep the AlCl₃ suspended and added to the addition funnel. The solution was added dropwise at 3 drops/sec to 4.6165 g of DB18C6. After the addition, the flask was swirled at room temperature for 15 minutes. The solution was extracted with 125 mL of HCl and separated. The aqueous phase was filtered, and the organic phase was evaporated. The fifth experiment included dissolving DB18C6 in chloroform which was added to AlCl₃. 4.6065 g of DB18C6 was dissolved in 75 mL of chloroform, added it to the addition funnel, and added it at a rate of 3 drops/sec to approximately 1 g of AlCl₃. After the addition, the flask was swirled at room temperature for 15 minutes. After extraction with 75 mL of concentrated HCl, the aqueous phase was filtered, and the organic phase was evaporated.

### Crown Ether Integrated Polymer Synthesis Using a Merrifield Resin

As discussed, the crown ether integrated polymer of the present disclosure may be configured to enable solid phase extraction of Sr-90 in an aqueous solution. As illustrated in Schemes I and II, the crown ether integrated polymer may synthesized utilizing a Merrifield resin or may be integrated into the Merrifield resin. The Merrifield resin may be a resin that carries a methyl chloride group on some of the aromatic rings. In this regard, a highly-substituted Merrifield resin may have sites for DB18C6 to react and attach itself to the resin through covalent bonds. Advantageously, this example synthesis enables incorporation of the crown ether structure into a large molecule with few reaction steps, further enabling a large polymer size and stability. Here, either a DB18C6 or a benzo-18-crown-6 ether (“B18C6”) may be used as the crown ether. For example, and with reference to Scheme I, a simplified synthesis scheme for polymerizing DB18C6 with a Merrifield Resin is shown. As another example, and with reference to Scheme II, a simplified synthesis scheme for polymerizing B18C6 with a Merrifield Resin is shown.

In this regard, such reactions may be facilitated by preparing a first solution including a crown ether (e.g., DB18C6 or B18C6) and a Merrifield resin (e.g., a cross-linked polystyrene resin carrying a chloromethyl functional group) and preparing a second solution including an acid (e.g., aluminum trichloride or iron trichloride) and a Merrifield resin. The first solution and the second solution may be added together, resulting in a third solution. The reaction may be designed such that the third solution results in a 1:1:1.25 mole ration of AlCl₃, Merrifield resin, and crown ether. However, the molar ration may be adjusted based on the number of methyl chloride sites of the Merrifield resin. In one example, the addition of the second solution to the first solution is done under cooling conditions, such as by placing a flask holding the first solution in an ice bath as the second solution is added thereto. In one example, the second solution is added to a separatory funnel and dripped into the first solution to prevent overboiling, as HCl gas will be produced. In this regard, the bubbling system, such as that illustrated in FIG. 1 may be employed to control the production of HCl. In this regard, the HCl gas may be routed through the bubbling system and submerged into a basic solution (e.g., NaOH).

Following complete addition of the second solution to the first, the third solution may be heated to a boiling point to remove any excess cyclohexane produced by the reaction. Thereafter, an extraction may be performed with a methanol solution (e.g., 50% methanol solution) or ethanol solution to remove any residual acid. Then, an organic layer of the third solution may be isolated and allowed to cool. At this point, a precipitate may form including the crown ether integrated polymer (i.e., an 18C6 integrated into a resin). The precipitate of the organic layer may be collected (e.g., via vacuum filtration) including the crown ether integrated polymer.

### Ether-Linked Polymer Synthesis Through a Duff Reaction—Route 1

As discussed, the crown ether integrated polymer of the present disclosure may be configured to enable solid phase extraction of Sr-90 in an aqueous solution. As illustrated in Schemes III-V, the crown ether integrated polymer may be an ether-linked polymer synthesized utilizing a Duff reaction with a Smith modification. In this regard, a DB18C6 goes through a Duff reaction to produce a cis-diformyl substituted DB18C6. This may be facilitated by preparing a first solution including a crown ether (e.g., DB18C6), hexamethylenetetramine (“HMTA”), and trifluoroacetic acid (“TFA”). Thereafter, the first solution may be heated (e.g., to about 90° C.) and stirred for an amount of time (e.g., about 12 hours). Such a reaction is illustrated by the simplified reaction scheme of Scheme III and results in a cis-diformyl DB18C6 being formed. In one example, the first solution includes a 3:3:1 molar ratio of TFA, HMTA, and DB18C6, advantageously ensuring that the crown ether has excess TFA and HMTA to allow for formylation. In one example, an extraction may be formed using diethyl ether to isolate the cis-diformyl DB18C6 for analytical purposes, if desired.

Next, the aldehydes (i.e., cis-diformyl DB18C6) need to be reduced to primary alcohols, which may be accomplished with a mild reducing agent (e.g., NaBH₄). Advantageously, by utilizing NaBH₄, the reducing agent is mild enough to reduce the aldehydes, but not affect the benzene or ether. In one example, this reaction is facilitated by dissolving the cis-diformyl DB18C6 in ethanol and then adding an ethanol solution including NaBH₄ thereto (e.g., with a 1:1 molar ratio of cis-diformyl DB18C6 to NaBH₄). Such a reaction may occur under cooling conditions (e.g., within an ice bath) and stirred (e.g., with a magnetic stir bar) for an amount of time (e.g., 15 to 45 minutes). Thereafter, the ethanol may be evaporated, for example utilizing low heating or a rotary evaporator, isolating a precipitate. The solid precipitate may then be suspended in a dichloromethane solution. In one example, this reaction is quenched by adding HCl, dropwise, to the dichloromethane solution. Thereafter, an extraction may be performed on an aqueous phase of the solution with at least one wash of DCM and an evaporation may be performed on an organic layer (e.g., utilizing a rotary evaporator). Such a reaction is illustrated by the simplified reaction scheme of Scheme IV, resulting in reduction of the aldehydes on the crown ether into primary alcohols and formation of a crown ether dibenzyl alcohol product.

The final step of this example synthesis is an acid-catalyzed dehydration reaction to produce an ether-linked crown ether integrated polymer. This may be accomplished by adding the ether of the previous step (i.e., within the organic layer) to an acid solution. For example, the acid solution may be designed to have a 1:2 molar ratio of ether to acid (e.g., sulfuric acid). The acid solution may be refluxed for an amount of time (e.g., about 3 hours). In one example, temperature conditions of this reaction are controlled to aid in polymer formation, for example by ensuring the reflux is conducted under a temperature range of 130° C. to 140° C. In another example, the temperature may be slowly increased, not exceeding 140° C., during reflux. In another example, the temperature is slowly heated from room temperature to about 100° C., during reflux. Following reflux, the resulting solution may be placed in a beaker and stirred for an amount of time (e.g., 30 minutes) to ensure a long polymerization process. Thereafter, a precipitate may be formed and collected (i.e., including the crown ether integrated polymer) utilizing, for example, vacuum filtration. Such a reaction is illustrated by the simplified reaction scheme of Scheme V, resulting in synthesis of a crown ether integrated polymer and more particularly an ether-linked polymer.

### Ether-Linked Polymer Synthesis Through a Duff Reaction—Route 2

The present disclosure contemplates an alternative route to the synthesis of an ether-linked polymer through a Duff reaction. In this example, the ether dibenzyl alcohol product (is initially synthesized as illustrated in Schemes III and IV. Such synthesis may be substantially similar to that previously discussed in reference to Route 1, redundant explanation of which is excluded for clarity. Here, about half of the ether dibenzyl alcohol product initially synthesized may be collected and set aside as a reagent for a later step of route 2, which is illustrated in Schemes VI-VIII. The remaining half may have the alcohols converted into an alkyl halide by addition of HCl and heat to a solution containing the ether dibenzyl alcohol product. In one example, the solution contains about a 3:1 molar ratio of HCl to ether and is heated to a boiling point. Following the heating step, the resulting solution may be refluxed in, for example, a reflux column for an amount of time (e.g., about 45 minutes). In another example, SOCl₂ is used instead of HCl. Thereafter, the alkyl halide ether product is isolated (e.g., by separating an organic layer with a separatory funnel) and then washed. Washing may be accomplished with water and subsequently washed with concentrated sodium bicarbonate. The resulting product (i.e., alkyl halide crown ether) may be dried with a drying agent if needed. Such a reaction is illustrated by the simplified reaction scheme of Scheme VI, resulting in synthesis of a crown ether alkyl halide.

Now, an alkoxide must be generated to react with the alkyl halide crown ether to synthesize the crown ether integrated polymer. In this regard, the ether dibenzyl alcohol product previously synthesized may have its alcohols converted into alkoxides. In one example, the ether dibenzyl alcohol product is reacted with NaH to produce a crown ether alkoxide, however, this reaction may generate hydrogen gas and react violently with water. In another example, the ether dibenzyl alcohol product is reacted with sodium tert-butoxide (“tBuONa”) to produce the crown ether alkoxide, advantageously providing a less volatile route. In one example, the solution of crown ether dibenzyl alcohol product and tBuONa includes about a 2.2:1 mole ratio of tBuONa to crown ether dibenzyl alcohol product. To encourage the reaction, the solution may be heated and stirred for an amount of time (e.g., about 20 minutes). Such a reaction is illustrated by the simplified reaction scheme of Scheme VII resulting in synthesis of a crown ether alkoxide.

Following synthesis of the crown ether alkoxide and crown ether alkyl halide, the two may be combined with a tert-butyl alcohol (“tBuOH”) to form a crown ether integrated polymer (e.g., DB18C6 ether linked polymer). To facilitate the foregoing, a solution of the crown ether alkoxide and tBuOH may be prepared. In one example, the solution includes a 2.2:1 mole ratio of tBuOH and crown ether (e.g., DB16C6). This solution may be stirred under heating conditions for an amount of time (e.g., about 20 minutes). Thereafter, the crown ether alkyl halide may be added to the solution and refluxed for an amount of time (e.g., 45 minutes). The resulting solution may be quenched with an equivalent volume of water and allowed to cool. During cooling, a crystalline precipitate may begin to form. In one example, the solution is placed in an ice bath to encourage crystallization. Subsequent crystallizations may be performed to remove any impurities. The crystalline precipitate me be isolated from the solution (e.g., via vacuum filtration) and contains the crown ether integrated polymer and more particularly an ether-linked polymer. Such a reaction is illustrated by the simplified reaction scheme of Scheme VIII resulting in synthesis of a crown ether integrated polymer (e.g., a DB18C6 ether linked polymer).

The previously described crown ether integrated polymers are configured to capture Sr-90 ions from an aqueous solution (i.e., one containing one or more fission products from a molten salt ultimately derived by fission reactions) via adsorption within their central cavity, thereafter the crown ether integrated polymer may be stripped to isolate the Sr-90. Advantageously, by polymerizing the crown ether, extraction may be facilitated by solid phase extraction (“SPE”). The crown ether integrated polymer may be utilized in an SPE column. For example, and with reference to FIG. 2, a process for extracting Sr-90 from an aqueous solution of fission products utilizing an SPE column is shown. As illustrated in FIG. 2, the crown ether integrated polymer may be formed into or integrated with a central filter of a SPE column, for example, interposed between two filter disks. In this regard, an aqueous solution of fission products including Sr-90 may be passed through the SPE column where the Sr-90 is adsorbed by the crown ether integrated polymer of the central filter, resulting in the remaining fission products passing therethrough. In one example, a masking agent (e.g., sodium tetraphenylborate) may be included in the aqueous solution prior to input into the SPE column. In this regard, selectivity of the crown ether integrated polymer may be increased as the masking agents may bind to non-Sr-90 atoms, which may otherwise be captured by the crown ether integrated polymer. Thereafter, a solvent may be passed through the SPE cartridge to strip the crown ether integrated polymer of the central filter of the Sr-90 initially captured, resulting in a solution of isolated Sr-90. In one example, the solvent is water, HCl, or a combination of water and HCl.

The SPE techniques illustrated in FIG. 2 may utilize any of the aforementioned crown ether integrated polymers. Additional reaction parameters, such as temperature, acidity, and Sr-90 concentration, may be altered to encourage or increase the effectiveness of Sr-90 capture by the crown ether integrated polymer. For example, a masking agent (e.g., sodium tetraphenylborate) may be included in the aqueous solution of fission products to increase the selectivity of the crown ether integrated polymer. For example, generation of the Sr²⁺/CE complex (e.g., that illustrated in Scheme XI) is exothermic, thus Le Chatelier's principle indicates that if heat were to be removed then the reaction will shift towards the product side, consequently increasing adsorption. In this regard, the SPE technique illustrated in FIG. 2 may be done under cooling conditions, such as by having the SPE column within an ice bath. As another example, the aqueous solution containing the various fission products and Sr-90 may be acidified prior to SPE. In this regard, a nitric acid may be added to the aqueous solution prior to extraction, for example in 2 to 5 molar concentrations, advantageously increasing the adsorption of Sr-90. Lastly, the initial concentration of Sr-90 in the aqueous solution may be increased to increase the adsorption rate during extraction.

In at least one example, the crown ether integrated polymer of the present invention may be employed as a Phase Transfer Agent (PTA) operable to extract Sr-90 ions from an aqueous phase and into an organic phase. In this regard, the crown ether integrated polymer may have certain parameters or synthesis procedures altered to produce an organically-solvable analog, which may be included in an organic solution making contact with the aqueous solution containing the Sr-90 ions. In this example, the crown ether integrated polymer may extract the Sr-90 ions from the aqueous phase and into the organic phase, enabling alternative extraction and purification methods.

Further applicability of the crown ether integrated polymer includes remediation of nuclear waste spills. In this regard, the crown ether integrated polymer of the present disclosure may be employed with nuclear waste or a spill site rather than an aqueous solution. In this example, the crown ether integrated polymer may be submerged in the nuclear waste or spill site and adsorbed Sr atoms found therein. Advantageously, the crown ether integrated polymer may be employed to extract potentially hazardous material from a nuclear waste or spill site.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A method of capturing strontium-90 from an aqueous solution comprising:
providing an aqueous solution comprising strontium-90;
acidifying the aqueous solution; and
exposing the aqueous solution to an ether-linked polymer comprising a plurality of dibenzo-18-crown-6 moieties covalently bonded to one another through alkyl or benzyl ether linkages.

2. The method of claim 1, wherein the exposing comprises solid-phase extraction of the strontium-90 from the aqueous solution.

3. The method of claim 1, wherein the exposing step is done under cooling conditions

4. The method of claim 1, wherein the acidifying step comprises adding nitric acid in two molar to five molar concentration to the aqueous solution.

5. The method of claim 1, wherein the aqueous solution comprises dissolved fission products from a molten salt reactor.

6. A method for synthesizing a crown-ether-integrated polymer through Friedel-Crafts alkylation comprising:
combining a first solution comprising dibenzo-18-crown-6 ether and a polysubstituted alkyl halide selected from the group consisting of 1,2-dichloroethane, oxalyl chloride, and chloroacetyl chloride with a second solution comprising aluminum trichloride and said polysubstituted alkyl halide to produce a reaction mixture;
rinsing the reaction mixture;
separating an organic layer from the reaction mixture; and
collecting a precipitate from the organic layer, wherein the precipitate comprises the crown-ether-integrated polymer.

7. The method of claim 6, wherein the polysubstituted alkyl halide comprises 1,2-dichloroethane and wherein the mole ratio of aluminum trichloride to 1,2-dichloroethane to dibenzo-18-crown-6 ether is 4:2:1.

8. The method of claim 6, further comprising capturing hydrogen chloride gas evolved during the combining step via a bubbling system.

9. The method of claim 6, further comprising boiling an ethanol solution that contains the precipitate.

10. A method for synthesizing a crown-ether-integrated polymer comprising:
combining a first solution comprising a crown ether selected from dibenzo-18-crown-6 ether or benzo-18-crown-6 ether and a Merrifield resin with a second solution comprising aluminum trichloride to produce a reaction mixture; heating the reaction mixture to a boiling point;
adding methanol to the reaction mixture; separating an organic layer from the reaction mixture; and
collecting a precipitate from the organic layer, wherein the precipitate comprises a crosslinked polymer network comprising a plurality of crown ether moieties covalently bonded to each other and to the Merrifield resin.

11. The method of claim 10, further comprising capturing and condensing hydrogen chloride gas produced as a byproduct via a bubbling system into a basic solution.

12. The method of claim 10, wherein the combining step is done under cooling conditions.

13. A method for synthesizing an ether-linked crown ether polymer comprising:
reducing a cis-diformyl dibenzo-18-crown-6 ether with sodium borohydride in ethanol to produce a crown ether dibenzyl alcohol;
suspending the crown ether dibenzyl alcohol in dichloromethane;
adding sulfuric acid to produce a reaction mixture;
heating the reaction mixture under reflux conditions to effect acid-catalyzed dehydrative coupling; and
collecting a precipitate comprising the ether-linked crown ether polymer.

14. The method of claim 13, further comprising, prior to the reducing step, preparing the cis-diformyl dibenzo-18-crown-6 ether by heating dibenzo-18-crown-6 ether with hexamethylenetetramine and trifluoroacetic acid in a 1:3:3 molar ratio.

15. The method of claim 13, wherein the reducing step is performed under cooling conditions.

16. A method for synthesizing an ether-linked crown ether polymer comprising:
converting a first portion of a crown ether dibenzyl alcohol to an alkyl halide by reaction with hydrochloric acid or thionyl chloride;
converting a second portion of the crown ether dibenzyl alcohol to an alkoxide by reaction with sodium tert-butoxide in tert-butyl alcohol;
combining the alkyl halide and the alkoxide in tert-butyl alcohol;
refluxing to effect coupling; and
collecting a precipitate comprising the ether-linked crown ether polymer.

17. The method of claim 16, wherein the crown ether dibenzyl alcohol is derived from dibenzo-18-crown-6 ether.

18. The method of claim 16, further comprising washing the precipitate with a sodium bicarbonate aqueous solution.

19. The method of claim 16, wherein the molar ratio of sodium tert-butoxide to crown ether dibenzyl alcohol is 2.2:1.

20. The method of claim 16, wherein the converting of the first portion of the crown ether dibenzyl alcohol to an alkyl halide is performed with hydrochloric acid.
